(19) United States
(12) Patent Application Publication
(10) Pub. No.: US 2022/0044903 A1
(43) Pub. Date: Feb. 10, 2022

(54) ARC-MITIGATING FUSE WITH GAS EVOLVING MICROBEADS

(71) Applicant: Littelfuse, Inc., Chicago, IL (US)

(72) Inventors: IRMA VALERIANO SANTOS, Chicago, IL (US); TODD GORDON DIETSCH, Park Ridge, IL (US)

(73) Assignee: Littelfuse, Inc., Chicago, IL (US)

(21) Appl. No.: 17/389,604

(22) Filed: Jul. 30, 2021

Related U.S. Application Data
(60) Provisional application No. 63/062,595, filed on Aug. 7, 2020.

(51) Int. Cl. H01H 85/42

(52) U.S. Cl. CPC H01H 85/42; H01H 2085/388

(57) ABSTRACT

An arc-mitigating fuse including a fuse body, a first endcap covering a first end of the fuse body and a second endcap covering a second end of the fuse body, a fusible element disposed within the fuse body and extending between the first endcap and the second endcap to provide an electrically conductive pathway therebetween, and a plurality of gas-evolving microbeads disposed within the fuse body surrounding the fusible element.

### CROSS-REFERENCE TO RELATED APPLICATIONS

This application claims the benefit of U.S. Provisional Patent Application No. 63/062,595, filed Aug. 7, 2020, which is incorporated by reference herein in its entirety.

### FIELD OF THE DISCLOSURE

The present disclosure relates generally to the field of circuit protection devices and relates more particularly to an arc-mitigating fuse.

### FIELD OF THE DISCLOSURE

Fuses are commonly used as circuit protection devices and are typically installed between a source of electrical power and a component in a circuit that is to be protected. One type of fuse, commonly referred to as “cartridge fuse” or “tube fuse,” includes a fusible element disposed within a hollow, electrically insulating fuse body. Upon the occurrence of a specified fault condition, such as an overcurrent condition, the fusible element melts or otherwise opens to interrupt the flow of electrical current between the electrical power source and the protected component.

When the fusible element of a fuse is melted during an overcurrent condition, it is sometimes possible for an electrical arc to propagate between the separated portions of the fusible element (e.g., through vaporized particulate of the melted fusible element). If not extinguished, this electrical arc may allow significant follow-on currents to flow to the protected component, resulting in damage to the component despite the physical opening of the fusible element. Thus, it is desirable to provide a fuse that effectively prevents or mitigates electrical arcing during overcurrent conditions.

It is with respect to these and other considerations that the present improvements may be useful.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

An exemplary embodiment of an arc-mitigating fuse in accordance with the present disclosure may include a fuse body, a first endcap covering a first end of the fuse body and a second endcap covering a second end of the fuse body, a fusible element disposed within the fuse body and extending between the first endcap and the second endcap to provide an electrically conductive pathway therebetween, and a plurality of gas-evolving microbeads disposed within the fuse body surrounding the fusible element.

### BRIEF DESCRIPTION OF THE DRAWINGS

FIG. 1 is an isometric cutaway view illustrating an arc-mitigating fuse in accordance with an exemplary embodiment of the present disclosure.

The drawings are not necessarily to scale. The drawings are merely representations, not intended to portray specific parameters of the disclosure. The drawings are intended to depict xample embodiments of the disclosure, and thus are not to be considered as limiting in scope. In the drawings, like numbering represents like elements.

Furthermore, certain elements in some of the figures may be omitted, or illustrated not-to-scale, for illustrative clarity. The cross-sectional views may be in the form of “slices”, or “near-sighted” cross-sectional views, omitting certain background lines otherwise visible in a “true” cross-sectional view, for illustrative clarity. Furthermore, for clarity, some reference numbers may be omitted in certain drawings.

### DETAILED DESCRIPTION

Embodiments of an arc-mitigating fuse in accordance with the present disclosure will now be described more fully with reference to the accompanying drawings, in which preferred embodiments of the present disclosure are presented. The arc-mitigating fuse of the present disclosure may, however, be embodied in many different forms and should not be construed as being limited to the embodiments set forth herein. Rather, these embodiments are provided so that this disclosure will be thorough and complete, and will fully convey the scope of the arc-mitigating fuse to those skilled in the art. In the drawings, like numbers refer to like elements throughout unless otherwise noted.

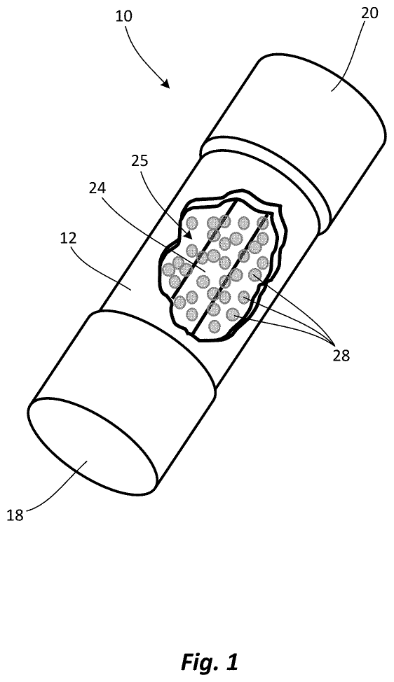

Referring to FIG. 1, an isometric cutaway view illustrating an arc-mitigating fuse 10 (hereinafter “the fuse 10”) in accordance with an exemplary embodiment of the present disclosure is shown. The fuse 10 may be a cartridge fuse having a tubular fuse body 12 formed of an electrically insulating material. The present disclosure is not limited in this regard. In various alternative embodiments, the fuse 10 may be a surface mount fuse or other type of fuse having a fusible element extending through a generally hollow fuse body. The fuse body 12 may be a round cylinder as shown in FIG. 1, but this is not critical. Alternative embodiments of the fuse 10 may include a fuse body that is a square cylinder, an oval cylinder, a triangular cylinder, etc. The present disclosure is not limited in this regard. The fuse body 12 of the fuse 10 may be formed of an electrically insulating and preferably heat resistant material, including, but not limited to, ceramic or glass.

A pair of electrically conductive endcaps 18, 20 may be disposed on opposing ends of the fuse body 12. A fusible element 24 may extend through the hollow interior 25 of the fuse body 12 and may be connected to the endcaps 18, 20 in electrical communication therewith, such as by solder. The endcaps 18, 20 may be formed of an electrically conductive material, including, but not limited to, copper or one of its alloys, and may be plated with nickel or other conductive, corrosion resistant coatings. The fusible element 24 may be formed of an electrically conductive material, including, but not limited to, tin or copper, and may be configured to melt and separate upon the occurrence of a predetermined fault condition, such as an overcurrent condition in which an amount of current exceeding a predefined maximum current flows through the fusible element 24. The fusible element 24 may be any type of fusible element suitable for a desired application, including, but not limited to, a fuse wire, a corrugated strip, a fuse wire wound about an insulating core, etc. In some embodiments the fusible element 24 may extend diagonally through the hollow interior 25 of the fuse body 12. The present disclosure is not limited in this regard.

The hollow interior 25 of the fuse body 12 may be partially or entirely filled with a quantity of gas-evolving microbeads 28 (hereinafter “the microbeads 28”). The microbeads 28 may be generally spherical particles measuring about 1 millimeter or less in their largest dimension. The microbeads 28 may be made from a petrochemical plastic such as polyethylene, polypropylene, or polystyrene, or other similar materials that are selected to rupture, melt, or otherwise break down when subjected to heat and/or pressure upon the occurrence of an overcurrent condition in the fuse 10 (as further described below). The present disclosure is not limited in this regard. The microbeads 28 may be filled with an arc-quenching gas (e.g., nitrogen, carbon dioxide, sulfur hexafluoride, etc.) or a gas-evolving material that produces an arc-quenching gas when vaporized (e.g., melamine, dicyandiamide, hexamethylenetetramine, etc.).

Upon the occurrence of an overcurrent condition in the fuse 10, the fusible element 24 may melt and separate, during which heat and pressure may increase within the fuse body 12. This increase in heat and pressure may rupture, melt, or otherwise breakdown the microbeads 28, allowing the arc-quenching gas (or gas-evolving material that produces arc-quenching gas when vaporized) within the microbeads 28 to be released. The arc-quenching gas may rapidly draw heat away from the separated ends of the fusible element 24 and any electrical arc spanning therebetween, thereby quenching the electrical arc and preventing or mitigating damage that might otherwise be caused to connected electrical components if the arc was allowed to propagate or persist.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

1. An arc-mitigating fuse comprising:
a fuse body;
a first endcap covering a first end of the fuse body and a second endcap covering a second end of the fuse body;
a fusible element disposed within the fuse body and extending between the first endcap and the second endcap to provide an electrically conductive pathway therebetween; and
a plurality of gas-evolving microbeads disposed within the fuse body surrounding the fusible element.

2. The arc-mitigating fuse of claim 1, wherein the gas-evolving microbeads are adapted to rupture upon an increase of heat or pressure within the fuse body.

3. The arc-mitigating fuse of claim 1, wherein the gas-evolving microbeads are filled with an arc-quenching gas.

4. The arc-mitigating fuse of claim 3, wherein the arc-quenching gas includes at least one of nitrogen, carbon dioxide, and sulfur hexafluoride.

5. The arc-mitigating fuse of claim 1, wherein the gas-evolving microbeads are filled with a gas-evolving material that produces an arc-quenching gas when vaporized.

6. The arc-mitigating fuse of claim 5, wherein the gas-evolving material includes at least one of melamine, dicyandiamide, and hexamethylenetetramine.

7. The arc-mitigating fuse of claim 1, wherein the microbeads are spherical and measure up to 1 millimeter in their largest dimension.

8. The arc-mitigating fuse of claim 1, wherein the microbeads are microbeads are made from a petrochemical plastic.

9. The arc-mitigating fuse of claim 1, wherein the fusible element is one of a fuse wire, a corrugated strip, and a fuse wire wound about an insulating core.

10. The arc-mitigating fuse of claim 1, wherein the fuse body is formed of one of ceramic and glass.
